(19) United States
(12) Patent Application Publication
(10) Pub. No.: US 2023/0122952 A1
(43) Pub. Date: Apr. 20, 2023

(54) DIFFERENTIAL BRAKING TO INCREASE EVASIVE MANEUVER LATERAL CAPABILITY

(71) Applicants: Steering Solutions IP Holding Corporation, Auburn Hills, MI (US); Continental Automotive Systems, Inc., Auburn Hills, MI (US)

(72) Inventors: JOSEPH A. LABARBERA, BIRCH RUN, MI (US); CLINTON L. SCHUMANN, HOLLY, MI (US); SCOTT T. SANFORD, SWARTZ CREEK, MI (US); MICHAEL WYCIECHOWSKI, GRAND BLANC, MI (US)

(21) Appl. No.: 17/504,404

(22) Filed: Oct. 18, 2021

(51) Int. Cl. B60T 8/24; B60T 8/94; B60T 8/171

(52) U.S. Cl. CPC B60T 8/246; B60T 8/94; B60T 8/171; B60T 2250/03; B60T 2260/024

(57) ABSTRACT

A number of variations are discloses including a system and method including using differential braking to increase evasive lateral maneuver capability.

### TECHNICAL FIELD

The field to which the disclosure generally relates to includes steering, braking, and propulsion systems.

### BACKGROUND

Vehicles typically include steering systems including electric power steering systems.

### SUMMARY OF ILLUSTRATIVE VARIATIONS

A number of variations may include a system and method including applying, comprising using at least one electronic processor, differential braking to roadwheels of a vehicle to increase evasive maneuver lateral capability.

A number of variations may include a system and method including applying, comprising using at least one electronic processor, differential braking to roadwheels of a vehicle to increase evasive maneuver lateral capability while an electric power steering system has failed.

A number of variations may include a system and method including applying, comprising using at least one electronic processor, differential braking to roadwheels of a vehicle to increase evasive maneuver lateral capability while an electric power steering is operational.

A number of variations may include a system and method including applying, comprising using at least one electronic processor, a differential braking force to roadwheels of a vehicle to increase evasive maneuver lateral capability while an electric power steering is operational, failing or partially operational, or has failed.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an illustrative variation of a block diagram of a system and method of brake-to-steer functionality as steering system assist failure fallback;

FIG. 2 depicts an illustrative variation of a vehicle equipped with hardware sufficient for carrying out at least some of the systems and methods described herein;

FIG. 3 depicts an illustrative variation of a system or method including applying differential braking in an evasive maneuver of a vehicle;

FIG. 4 is an illustration of variations of the application of the application of differential braking and propulsion forces in an evasive maneuver of a vehicle; and

FIG. 5 is an illustration, in graph form, of an increase in yaw rate capability using differential braking in an evasive maneuver of a vehicle.

### DETAILED DESCRIPTION OF ILLUSTRATIVE VARIATIONS

The following description of the variations is merely illustrative in nature and is in no way intended to limit the scope of the invention, its application, or uses.

In evasive maneuver, a driver normally steers at a high handwheel velocity and an electric power steering assist motor provides assist to facilitate a rapid vehicle response to the driver's fast input. However, an electric power steering assist system component such as, but not limited to, a power pack or electric motor may fail. In such a case, the driver can reach very high torques very quickly and the vehicle will not respond as fast, increasing the risk of a collision in an avoidance maneuver. The lateral capabilities of differential braking may be utilized to provide a unique, diverse support method using a different actuator (brakes) that can help add lateral capability by adding yaw torque from braking forces. The same approach may be used for operational or semi-operational electric power steering systems (that have been reduced or degraded) to aid the driver and an evasive maneuver. This may enhance vehicle lateral capability and supplement the electric power system when the driver does a rapid handwheel maneuver to avoid an obstacle.

When an electronic power steering assist system includes a component such as, but not limited to, a powerpack or electric motor that has failed, a break to steer algorithm may be executed by an electronic processor and result in the production of brake pressure requests to individual wheels as a function of vehicle state information. The vehicle state information may include, for example, at least one of lateral acceleration or yaw rate, and if available, steering sensor measurements which may include, for example, at least one of torque or angle. The pressure request may be calculated in such a way as to provide enough breaking force on at least one roadwheel to generate a yaw torque, which in turn generates a lateral force that supplements the lateral force induced by the driver's manual steering. This may ultimately allow the vehicle to achieve higher yaw rate during an evasive maneuver than it would have achieved otherwise in a manual steering with loss of steering assist situation. If more information about driver intent is desired, an external steering column angle sensor may be used to indicate or determine driver's intent if the native steering angle sensor on the steering column is unavailable.

A number of variations may include a system and method including communicating, via at least one electronic processor, a request for application of a differential braking force to roadwheels of a vehicle to increase evasive maneuver lateral capability while an electric power steering assist is operational, failing or partially operational, or has failed. In a number of variations, the bracing force may be achieved by at least one of applying brake pad pressure to a brake disc or drum of roadwheel, or applying a force from a propulsion system in the reverse direction of travel of the vehicle. In a number of variations, the braking force for may be include running an electric propulsion motor of a roadwheel in the reverse direction of travel of the vehicle.

A number of variations may include a system or method including using steering wheel and vehicle state information as an input to a brake-to-steer system while electronic power steering assist system has failed. The brake-to-steer system may be used to add additional yaw torque to the driver induced steering angle in the event of an evasive maneuver, thus helping the driver achieve higher yaw rates in an emergency avoidance maneuver while the electronic power steering assist system is not operational and not able to provide assist. Vehicle dynamic signals indicating the state of the vehicles motion may be utilized, and also steering sensor signals when available. Alternatively, the function could be achieved to enhance lateral response during evasive maneuvers when the electronic power assist system is operational, partially operational or beginning to fail.

A number of variations may be constructed and arranged to be utilized in the following sequence of events. A driver maybe driving a vehicle with a normally functioning electric power steering system and at some point the electric power system controller or electric power system motor fails or shuts down so that it provides no motor output that can assist the driver in steering the vehicle. The driver is visually in audially informed of the failure by the vehicle lamps and alarms. The driver sees an obstacle ahead and attempts to perform an evasive maneuver by rapidly steering the steering wheel to avoid a collision. Lateral acceleration, yaw rate, and vehicle speed data may be sent to the brake-to-steer loss of assist support controller, and if available, signals regarding the steering angle, steering wheel rate, and steering torque are sent to the brake-to-steer loss of assist support controller. At the same time, the loss of assist controller running the brake-to-steer loss of assist support algorithm, or a brakes electric control unit, instantly sends pressure requests as a function of the aforementioned signals to the brakes electric control unit, which differentially distributes the pressure request to all four wheels. The yaw rate the vehicle is able to achieve has now increased due to the additional yacht torque generated by the differential breaking forces. Vehicle speed is maintained as much as possible during the break to steer event. The brake to steer function remains active and available to support the driver in any additional evasive maneuvers so that the driver can properly bring the vehicle to a safe state.

In a number of illustrative variations, a steering interface may comprise a handwheel, a joystick, a trackball, a slider, a throttle, a pushbutton, a toggle switch, a lever, a touchscreen, a mouse, or any other known means of user input.

In a number of illustrative variations, a vehicle may comprise a steering system comprising a steering interface and a steerable propulsion system such as, but not limited to, a steering wheel and road wheels, respectively.

In a number of illustrative variations, a vehicle may include electric braking system constructed and arranged to apply brake pressure to any number of road wheels to assist in steering a vehicle based upon driver steering interface input. The electric braking system may be in operable communication with the steering system and road wheel actuator assembly via at least one controller. The controller may implement any number of systems, including algorithms, for monitoring and controlling propulsion, steering, and braking. According to some variations, the electric braking system may be utilized to apply differential brake pressure to a number of wheels to effectuate lateral motion of the vehicle where a portion of a electric power steering system assist has failed.

In a number of illustrative variations, a brake-to-steer system may utilize a brake-to-steer algorithm executable by at least one electronic processor that may communicate brake pressure requests to individual wheels as a function of driver steering inputs including steering angle, steering angle rate, and steering torque. The brake-to-steer algorithm may communicate brake pressure requests when the system has detected evasive maneuver whether the electric power assist system is operation, partially operational or failing, or has failed.

Upon detection of evasive maneuver by the driver, the system may generate a visual or audio cue to a driver via a human to machine interface integrated into the vehicle. As a non-limiting example, the system may indicate via lamps or alarms that the brake-to-steer functional is being implemented. Driver input into the handwheel in the form of steering signals may include steering wheel angle, steering wheel rate, and steering torque may be communicated to a brake-to-steer driver directional controller. The brake-to-steer algorithm may receive said steering signals and calculate brake pressure requests as a function of steering signals to an electric braking system electric control unit. An electric braking system may provide a response to driver input of steering signals to reduce increase the yaw rate of the vehicle. In some cases, the system may provide for control of a vehicles propulsion system and may adjust throttle, speed, acceleration, and the like as needed to maintain driving speed and/or further enhance the yaw rate of the vehicle while the brake-to-steer system is operating. In some cases, the system may control a vehicles propulsion system to facilitate gradual slowing of a vehicle while the brake-to-steer system is operating.

According to some variations, a brake-to-steer system may be controlled by an external domain controller constructed and arranged to employ brake-to-steer functionality when an evasive maneuver is underway.

According to some variations, the brake-to-steer system may function by converting steering requests into a desired yaw rate which may then be converted into a corresponding brake pressure applied to the vehicle brakes in order to create the desired yaw rate with the driver controlling the steering wheel. Brake pressure may be applied to vehicle brakes via an electric braking system. Brake pressure may be applied to individual brake calipers as required.

Converting steering requests to actual yaw rate, and the conversion from your rate to brake pressure may be accomplished via calculation or look up tables. Similarly, converting steering angle to the appropriate brake pressures may also be accomplished via calculation or look up table.

According to some variations, the brake-to-steer system may continuously monitor vehicle speed, yaw rate, and lateral acceleration and may broadcast the availability of the brake-to-steer functionality to various other systems within the vehicle such that, if needed, brake-to-steer functionality may be implemented readily. According to some variations, the availability of the brake-to-steer system may include factoring in vehicle velocity data to determine the availability of the brake-to-steer system.

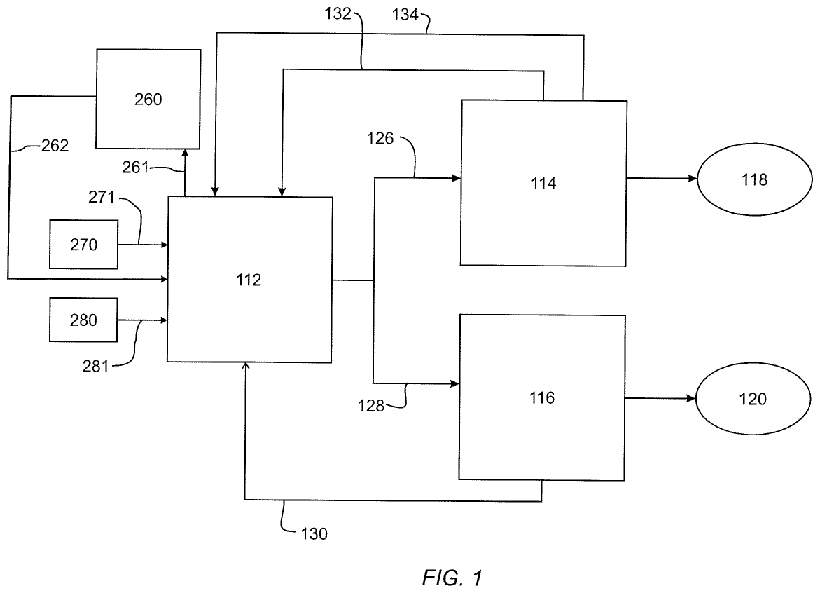

FIG. 1 depicts an illustrative variation of block diagram of a system and method of brake-to-steer as steering assist failure fallback. A vehicle may include a controller 112 constructed and arranged to receive driver steering input 134 via a steering system 114. The controller 112 may additionally be constructed and arranged to provide steering actuator commands 126 to the steering system 114. The steering system 114 may output tire angle changes 118 to affect steering system health status 132 to the controller 112. The controller 112 may also be constructed and arranged to provide braking commands 128 to an electric braking system 116 which, in turn, may apply brake pressure 120 to individual brake calipers. Where sensors and or the steering system 114 has indicated to the controller 112 that an evasive maneuver is underway, the controller 112 may send a brake movement request to provide differential braking at all roadwheels to increase yaw rate of the vehicle. If the steering system 114 indicates that a power steering assist has failed, the controller 112 may receive driver input 134 via a steering wheel and convert steering requests into brake pressure requests or commands 128 to be communicated to the electric braking system 116. The controller 112 may also receive input 271 from a variety of devices 270 designed to measure vehicle state information including, but not limited to lateral acceleration, yaw rate, wheel speed. The controller may receive input 281 from a variety of devices 280 that may include, but not limited to, gps, cameras, lidars, and radars that may be used in the algorithm to estimate a variety of vehicle states. The estimated vehicle states may be helpful, for example but not limited to, when steering wheel angle, torque, velocity sensors are not available. A longitudinal dynamic controller 260 may be provided to send torque request to accelerate or decelerate the front roadwheels wheels and/or rear roadwheels. The longitudinal dynamic controller 260 may receive input 261 from the controller 112 and may send output 262 to the controller 112 In a number of variations, a propulsions system may include separately controlled electric motor to provide a differential driving force to each roadwheel.

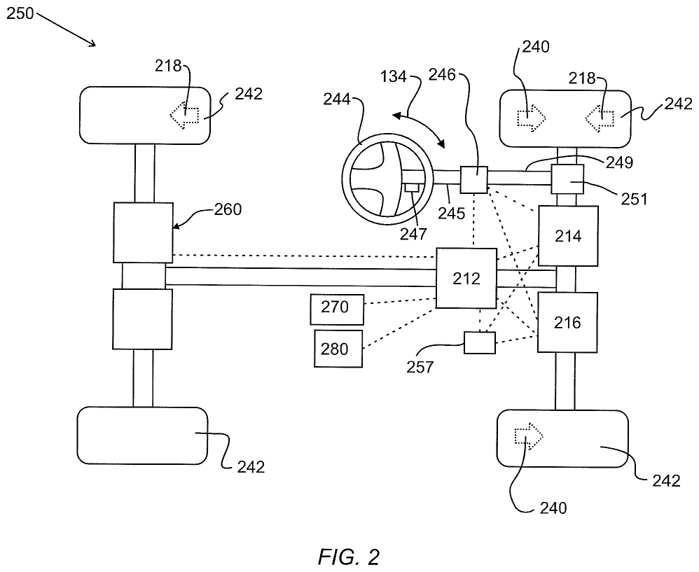

FIG. 2 depicts an illustrative variation of portions of a vehicle equipped with hardware sufficient for carrying out at least some of the systems and methods described herein. A vehicle 250 may include a controller 212 constructed and arranged to provide brake-to-steer functionality in a vehicle 250. The controller 212 may be in operable communication with a steering system 214 and an electric braking system 216. The steering system 214 and an electric braking system 216 may be in operable communication with at least one road wheel 242. A driver may utilize a handwheel 244 to provide driver input 134 for lateral movement and send steering requests to the steering system 214. In some variations, a steering assist 246 associated with the steering interface 244 may be in operable communication with the controller 212, the steering system 214, or the electric braking system 216. In some variations, the steering assist 246 may be disconnected or in a failure state 248 from or unable to communicate with the steering system 214. In such a variation, the steering sensor 247 may communicate steering requests to the controller 212, which may receive steering system 214 health status information. Where the controller 212 has received steering system 214 health status information indicative of a component, such as a steering assist 246 has failed, the controller 212 may convert steering requests from the steering senor 247 to brake pressure requests to be communicated to the electric braking system 216. The electric braking system 216 may apply brake pressure 218 to determined appropriate roadwheels 242 to effectuate lateral movement of the vehicle as input 134 by the driver via the handwheel 244. The controller 212 may also be constructed and arranged to make speed and acceleration requests 240 to a propulsion system onboard such that the vehicle may maintain or modify speed or acceleration during the use of brake-to-steer functionality to provide steering assist to the driver. If the steering sensor 247 is not operational, an external steering angle senor 257 may by provided at another location in the vehicle and communicate the driver's steering intent which may be used by the controller in the same manner with respect to the steering sensor regarding steering angle. Again, the controller 112 may also receive input 271 from a variety of devices 270 designed to measure vehicle state information including, but not limited to lateral acceleration, yaw rate, wheel speed. The controller may receive input 281 from a variety of devices 280 that may include, but not limited to, gps, cameras, lidars, and radars that may be used in the algorithm to estimate a variety of vehicle states. The estimated vehicle states may be helpful, for example but not limited to, when steering wheel angle, torque, velocity sensors are not available. The controller 112 may receive input and send output to a propulsion system.

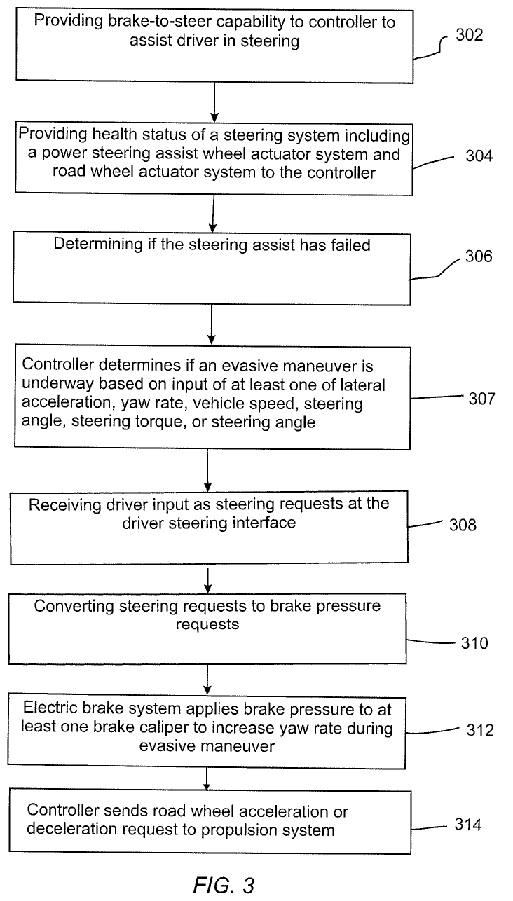

FIG. 3 depicts a simplified flowchart of an illustrative variation of a system for using brake-to-steer functionality to increase lateral capability during an evasive maneuver. The system may routinely or approximately continuously provide brake-to-steer capability to a controller 302 indicating readiness of the brake-to-steer functionality. At point 304, the steering system status, including steering assist health status, may be communicated to the motion controller. In some instances, the health status may indicate that portions of the steering assist are at risk of failing, failing, is malfunctioning or not operable. At point 306, the controller may receive the steering system health status and determine that the steering has failed. At point 307, the controller may receive lateral acceleration, yaw rate, vehicle speed, steering angle, steering torque, and/or steering wheel angle and determine if an evasive maneuver is being undertaken by the driver. At point 308, then controller receives drive input as steering requests at the driver steering interface. At point 310, the controller may convert steering requests to brake pressure requests. The input may come from a steering sensor if available or other devices that measure or may be used to estimate a vehicle state such as, but not limited to, lateral acceleration, yaw rate or wheel speed. Alternatively, the system may convert steering requests to vehicle yaw rate requests and convert yaw rate requests to brake pressure requests. At point 312, the electric brake system may receive brake pressure requests and apply brake pressure to individual brake calipers on a vehicle in order to increase the yaw rate of the vehicle. At point 314, the controller sends torque request to a propulsion system to meet roadwheel acceleration or deceleration request to further increase the yaw rate of the vehicle.

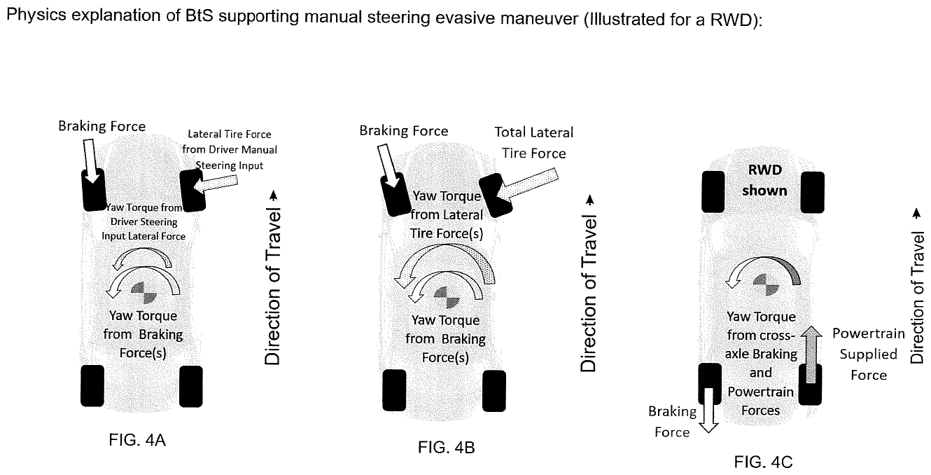

FIG. 4A illustrate a vehicle as a driver starts a manual evasive steering maneuver. The brake-to-steer algorithm execution by at least one electronic process results in braking forces that induce a yaw torque on the vehicle's center of gravity. Lateral tire force from drive manual steering input is illustrated.

FIG. 4B braking and lateral forces that move a steering rack of the vehicle with an increased total lateral tire force.

FIG. 4C illustrates a variation wherein longitudinal forces generated by the powertrain torque supplied (combined also with bracing forces across the rear axle of the vehicle to further increase yaw rate of the vehicle.

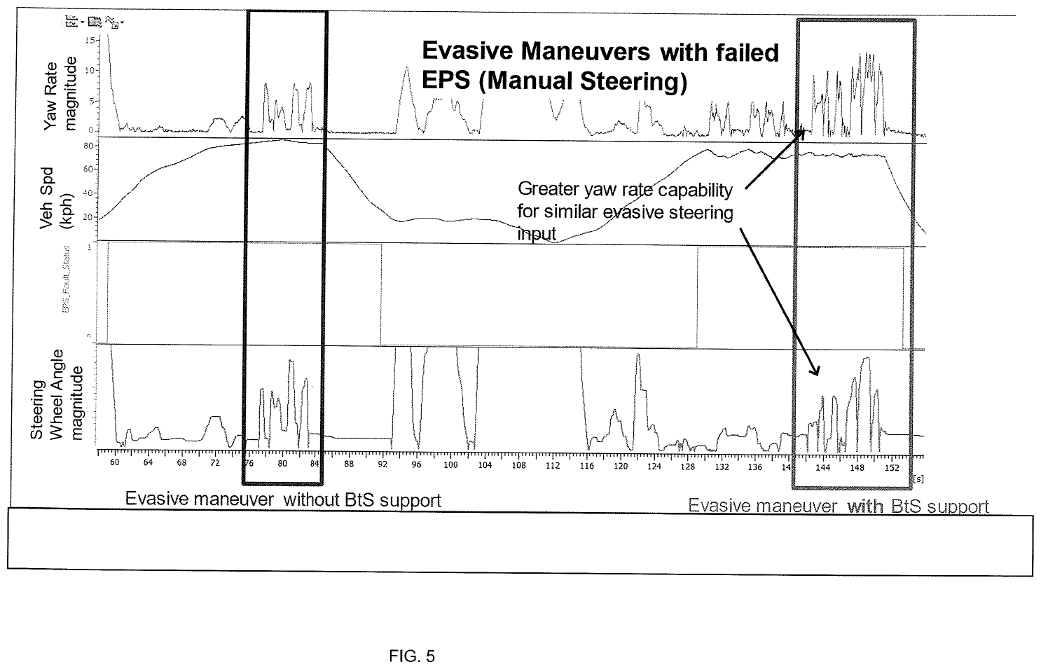

FIG. 5 is a graph of data collect during two evasive maneuvers. On the left side of the graph the data from an evasive maneuver without brake-to-steer functionality applied during loss of power steering assist. The right side of the graph the data from an evasive maneuver with brake-to-steer functionality applied during loss of power steering assist. As shown on the right side of the graph a greater yaw rate capability was achieved for a similar evasive steering input when differential braking was applied during the evasive maneuver.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

Variation 1 may include a method comprising determining, comprising using at least one processor, if an evasive steering maneuver is underway in a vehicle; and if an evasive steering maneuver is underway applying, comprising using the at least one electronic processor, a differential braking force to roadwheels of a vehicle to increase evasive maneuver lateral capability while an electric power steering is operational, failing or partially operational, or has failed.

Variation 2 may include a method as set forth in variation 1 wherein the electric power steering is operational.

Variation 3 may include a method as set forth in variation 1 wherein the electric power steering is failing or partially operational.

Variation 4 may include a method as set forth in variation 1 wherein the electric power steering has failed.

Variation 5 may include a method as set forth in variation 1 further comprising sending, comprising using the at least one electronic processor, an acceleration or a deceleration request to a propulsion system of the vehicle to further increase the yaw rate of the vehicle.

Variation 6 may include a method as set forth in variation 1 determining if an evasive steering maneuver is underway is based on at least one of lateral acceleration, yaw rate, vehicle speed, steering angle, steering torque, or steering wheel angle.

Variation 7 may include a method comprising determining, comprising using at least one processor, if an evasive steering maneuver is underway in a vehicle; and if an evasive steering maneuver is underway communicating, comprising using at least one electronic processor, a request for application of a differential braking force to roadwheels of a vehicle to increase evasive maneuver lateral capability while an electric power steering assist is operational, failing or partially operational, or has failed; wherein the bracing force is achieved by at least one of applying brake pad pressure to a brake disc or drum of roadwheel, or applying a force from a propulsion system in the reverse direction of travel of the vehicle.

Variation 8 may include a method as set forth in variation 7 wherein the braking force is achieved by applying a force from a propulsion system in the reverse direction of travel of the vehicle comprising an electric propulsion motor of a roadwheel in the reverse direction of travel of the vehicle.

Variation 9 may include a controller configured to cause differential braking to the roadwheels of a vehicle when an evasive steering maneuver is underway.

Variation 10 may include a controller as set forth in variation 9 wherein differential braking comprises applying an amount of brake pressure to at least one of the roadwheels to reduce the to increase the yaw rate of the vehicle.

Variation 11 may include a controller as set forth in variation 10 wherein the controller comprises an algorithm, executable by at least one electronic processor, to determine if an evasive steering maneuver is underway is based on at least one of lateral acceleration, yaw rate, vehicle speed, steering angle, steering torque, or steering wheel angle.

Variation 12 may include a computer readable media including instructions executable by an electronic processor to carry out the actions comprising: determining if determining if an evasive steering maneuver is underway in a vehicle; if an evasive steering maneuver is underway in a vehicle outputting brake pressure request to a brake system to apply an amount of brake pressure to at least one of the roadwheels to increase the yaw rate of the vehicle.

Variation 13 may include a method as set forth in variation 12 wherein the determining if an evasive steering maneuver is underway is based on at least one of lateral acceleration, yaw rate, vehicle speed, steering angle, steering torque, or steering wheel angle.

Variation 14 may include a method comprising determining, comprising using at least one processor, if an evasive steering maneuver is underway in a vehicle; and if an evasive steering maneuver is underway applying, comprising using the at least one electronic processor, a differential acceleration or deceleration force to roadwheels of a vehicle to increase evasive maneuver lateral capability.

Variation 15 may include a method as set forth in variation 14 wherein the applying comprises a acceleration force to roadwheels of a vehicle to increase evasive maneuver lateral capability.

The above description of select variations within the scope of the invention is merely illustrative in nature and, thus, variations or variants thereof are not to be regarded as a departure from the spirit and scope of the invention.

What is claimed is:

1. A method comprising determining, comprising using at least one processor, if an evasive steering maneuver is underway in a vehicle; and if an evasive steering maneuver is underway applying, comprising using the at least one electronic processor, a differential braking force to roadwheels of a vehicle to increase evasive maneuver lateral capability while an electric power steering is operational, failing or partially operational, or has failed.

2. A method as set forth in claim 1 wherein the electric power steering is operational.

3. A method as set forth in claim 1 wherein the electric power steering is failing or partially operational.

4. A method as set forth in claim 1 wherein the electric power steering has failed.

5. A method as set forth in claim 1 further comprising sending, comprising using the at least one electronic processor, an acceleration or a deceleration request to a propulsion system of the vehicle to further increase the yaw rate of the vehicle.

6. A method as set forth in claim 1 determining if an evasive steering maneuver is underway is based on at least one of lateral acceleration, yaw rate, wheel speed, steering angle, steering torque, or steering wheel angle.

7. A method comprising determining, comprising using at least one processor, if an evasive steering maneuver is underway in a vehicle; and if an evasive steering maneuver is underway communicating, comprising using at least one electronic processor, a request for application of a differential braking force to roadwheels of a vehicle to increase evasive maneuver lateral capability while an electric power steering assist is operational, failing or partially operational, or has failed; wherein the bracing force is achieved by at least one of applying brake pad pressure to a brake disc or drum of roadwheel, or applying a force from a propulsion system in the reverse direction of travel of the vehicle.

8. A method as set forth in claim 7 wherein the braking force is achieved by applying a force from a propulsion system in the reverse direction of travel of the vehicle comprising an electric propulsion motor of a roadwheel in the reverse direction of travel of the vehicle.

9. A controller configured to cause differential braking to the roadwheels of a vehicle when an evasive steering maneuver is underway.

10. A controller as set forth in claim 9 wherein differential braking comprises applying an amount of brake pressure to at least one of the roadwheels to reduce the to increase the yaw rate of the vehicle.

11. A controller as set forth in claim 10 wherein the controller comprises an algorithm, executable by at least one electronic processor, to determine if an evasive steering maneuver is underway is based on at least one of lateral acceleration, yaw rate, wheel speed, steering angle, steering torque, or steering wheel angle.

12. A computer readable media including instructions executable by an electronic processor to carry out the actions comprising: determining if determining if an evasive steering maneuver is underway in a vehicle; if an evasive steering maneuver is underway in a vehicle outputting brake pressure request to a brake system to apply an amount of brake pressure to at least one of the roadwheels to increase the yaw rate of the vehicle.

13. A method as set forth in claim 12 wherein the determining if an evasive steering maneuver is underway is based on at least one of lateral acceleration, yaw rate, wheel speed, steering angle, steering torque, or steering wheel angle.

14. A method comprising determining, comprising using at least one processor, if an evasive steering maneuver is underway in a vehicle; and if an evasive steering maneuver is underway applying, comprising using the at least one electronic processor, a differential acceleration or deceleration force to roadwheels of a vehicle to increase evasive maneuver lateral capability.

15. A method as set forth in claim 14 wherein the applying comprises a acceleration force to roadwheels of a vehicle to increase evasive maneuver lateral capability.
